(19) United States
(12) Patent Application Publication
(10) Pub. No.: US 2005/0034929 A1
(43) Pub. Date: Feb. 17, 2005

(54) Base leg for lift truck

(76) Inventors: John A. West, Vestal, NY (US); Jeffrey E. Greene, Port Crane, NY (US); Robert Lewis, Chenango Bridge, NY (US)

Correspondence Address: QUARLES & BRADY LLP, CITICORP CENTER, 500 WEST MADISON STREET, SUITE 3700, CHICAGO, IL, 60661-2511, US

(21) Appl. No.: 10/631,521

(22) Filed: Jul. 31, 2003

(51) Int. Cl. B66F 9/06

(52) U.S. Cl. 187/231

(57) ABSTRACT

A base leg assembly for lift trucks having a mounting plate, a base leg, and a load wheel assembly. The mounting plate is fastened to the mast structure or body structure of the lift truck and the base leg is fastened to the mounting plate. The base leg has a integrally cast mounting portion and leg portion that have cavities formed therein to reduce the weight of the base leg and to distribute stresses throughout the base leg to avoid stress concentrations. The proximal end of the leg portion extends laterally from the mounting portion and transitions in direction approximately 90 degrees such that the leg portion extends forward of the mounting portion and the lift truck at its distal end. Load wheel plates also have cavities formed therein and are fastened to the distal end of the base leg. Load wheels are disposed between the load wheel plates and are supported therein such that they can rotate.

### FIELD OF THE INVENTION

The present invention relates to lift trucks. In particular, the present invention relates to base legs and base leg assemblies used with lift trucks.

### BACKGROUND OF THE INVENTION

One type of fork lift truck that is well known and commonly found in warehouse and factory environments is the reach truck, such as the Reach-Fork® truck marketed by The Raymond Corporation of Greene, N.Y. In recent years, customer applications for such trucks have become more challenging, often requiring the lifting of greater loads, the lifting of loads to greater heights, and higher cycle rates. These market changes have imposed new design requirements on manufacturers of these types of fork lift trucks.

Reach trucks, as well as other types of fork lift trucks, or simply lift trucks, typically use base leg assemblies that consist of multiple parts that are welded together. As shown in FIG. 1, these base leg assemblies typically consist of a spacer 4, gusset plate 6, leg 8, and wheel plate assembly 10. The spacer 4 can be a single piece of tube steel or can be constructed of multiple pieces of sheet steel welded together to form the spacer 4. At one end, the spacer 4 is welded directly to the mast 2 of the lift truck. At the end of the spacer 4 opposite the mast 2, the spacer 4 is welded directly to the gusset plate 6. The leg 8 is usually a solid rectangular steel bar and is welded to the bottom of the gusset plate 6 and to spacer 4. The wheel plate assembly 10 is constructed of multiple pieces of machined steel that retain at least one load wheel 12 and is welded or bolted directly to the end of the leg 8.

One problem inherent in the current welded design of base leg assemblies is the weakness of the weld joints. This weakness is created by two problems. First, the weld joints in these base leg assemblies inherently contain residual stresses from the welding process. The only way to relieve this stress is to heat treat the base leg assemblies, which is not practical due to the size of the assemblies and the number of weld joints. Second, these base leg assemblies have abrupt transitions at the weld joints between the various parts. These abrupt transitions create high stress concentrations at the weld joints when the base leg assemblies are placed under a compressive load.

The combination of these problems during repeated operation imposes a compressive fatigue load onto a region containing residual stress. The weld joints are under residual stress when not under load and are subjected to repeated compressive forces each time the lift truck is operated. As the compressive force is removed, the weld joint then “springs back” to its residual stressed state. Due to the repeated compressive loads concentrated at the weld joints and the repeated “springing back” to a residual stressed state, the weld joints finally break due to fatigue. Particularly, the weld joint at the toe of the gusset plate (shown at 14 in FIG. 1) has limited fatigue life, which is a major disadvantage of the welded base leg assembly design.

A second problem inherent in most current welded designs is the difficulty of repair and the lack of interchangeability. With the current all welded design, when a base leg assembly or load wheel assembly is damaged, the damaged assembly must be cut away from the mast or base leg and a new assembly must be aligned and welded in its place. This type of repair requires a great deal of skill and time, is extremely expensive, and is not easily performed at remote locations. In addition, these welded base leg designs prevent the reconfiguration of the base legs for different customer applications. For example, the welded base leg assemblies cannot be adjusted to various base leg opening widths to accommodate varying pallet sizes. In addition, lift trucks that are rented cannot be configured to the requirements of the customer.

While there are some base leg assemblies that are designed to be removably secured to the mast or body of the lift truck, such as by bolts, these designs still contain various inherent problems. One such design is shown in U.S. Pat. No. 6,138,796. However, this design still uses the welded construction for the base leg, which leads to the weakness problem discussed above.

Given the wide use of lift trucks throughout varying industries, the mechanical design, performance, and reliability of the trucks are vital to their marketing success. However, due to the problems discussed above, each of these characteristics is severely limited by the current welded base leg design.

It would therefore be advantageous if a base leg assembly for reach trucks could be designed that: (1) had improved strength and reliability; and (2) provided easy repair, replacement, and interchangeability. In particular, it would be advantageous if the base leg assembly allowed for the even distribution of stresses throughout the base leg, was easy to assemble and disassemble, and allowed for various application specific configurations.

### SUMMARY OF THE INVENTION

One aspect of the present invention is a base leg assembly for lift trucks having a mounting plate that is fastened to the lift truck. A base leg has an integrally formed mounting portion and leg portion, wherein the mounting portion engages a mounting surface on the mounting plate and fastens to the mounting plate and the leg portion extends outward from the mounting portion and forward of the lift truck.

Integrally forming the mounting portion and leg portion of the base leg gives the base leg greater strength and reliability than those with welded design as it eliminates residual stresses and allows the distribution of stresses throughout the base leg.

Another aspect of the present invention is a base leg assembly having a mounting plate that has an internally threaded aperture and a bore. A base leg has a mounting portion that has an aperture aligned with the threaded aperture in the mounting plate and a second bore aligned with the bore in the mounting plate. The base leg is fastened to the mounting plate by inserting pins between the aligned bores, threading a threaded fastener into the internally threaded aperture in the mounting plate, inserting the threaded fastener through the aperture in the mounting portion of the base leg, and placing a nut on the threaded fastener.

Fastening the base leg to the mounting plate with pins and threaded fasteners makes the base leg easy to remove, repair, replace, or reconfigure. It also allows the easy reconfiguration of the base legs to allow for varying base leg openings and facilitates the customization of rented reach lift trucks to the requirements of customers.

Another aspect of the present invention is a base leg assembly having a base leg with an integrally formed leg portion that has a transverse bore at its distal end. A pair of load wheel plates extend forward from the distal end of the leg portion of the base leg and have a bore aligned with the transverse bore in the base leg. The load wheel plates are fastened to the base leg with a threaded fastener that extends through the bores and the transverse bore. A load wheel is mounted between the load wheel plates such that it can rotate therein.

Fastening the load wheel plates to the base leg with a threaded fastener allows for easier manufacture, easier repair or replacement of damage load wheels or load wheel plates, and facilitates the customization of the base leg assembly by easily allowing for various load wheel styles and sizes.

### BRIEF DESCRIPTION OF THE DRAWINGS

FIG. 1 is a perspective view of a base leg assembly having a typical welded design.

FIG. 2 is an exploded perspective view of the preferred embodiment of the base leg and mounting plate according to the present invention showing the top, outside, and front of the base leg and mounting plate.

FIG. 3 is a perspective view of the preferred embodiment of the base leg according to the present invention showing the top, inside, and front of the base leg.

FIG. 4 is a perspective view of the preferred embodiment of the base leg according to the present invention showing the bottom, outside, and back of the base leg.

FIG. 5 is a perspective view of the preferred embodiment of the load wheel plates according to the present invention.

FIG. 6 is a perspective view of the preferred embodiment of the assembled base leg and load wheel assembly according to the present invention.

FIG. 7 is a perspective view of an alternate embodiment of the base leg and mounting plate according to the present invention.

FIG. 8a is a top view of the preferred embodiment of the base leg according to the present invention.

FIG. 8b is a cross sectional view of the preferred embodiment of the base leg according to the present invention taken along line 8b-8b.

FIG. 8c is a cross sectional view of the preferred embodiment of the base leg according to the present invention taken along line 8c-8c.

FIG. 8d is a cross sectional view of the preferred embodiment of the base leg according to the present invention taken along line 8d-8d.

FIG. 8e is a cross sectional view of the preferred embodiment of the base leg according to the present invention taken along line 8e-8e.

FIG. 9 is a side view of the preferred embodiment of the lift truck and base leg assembly according to the present invention.

FIG. 10 is a top view of the preferred embodiment of the lift truck and base leg assembly according to the present invention.

### DETAILED DESCRIPTION OF THE PREFERRED EMBODIMENTS

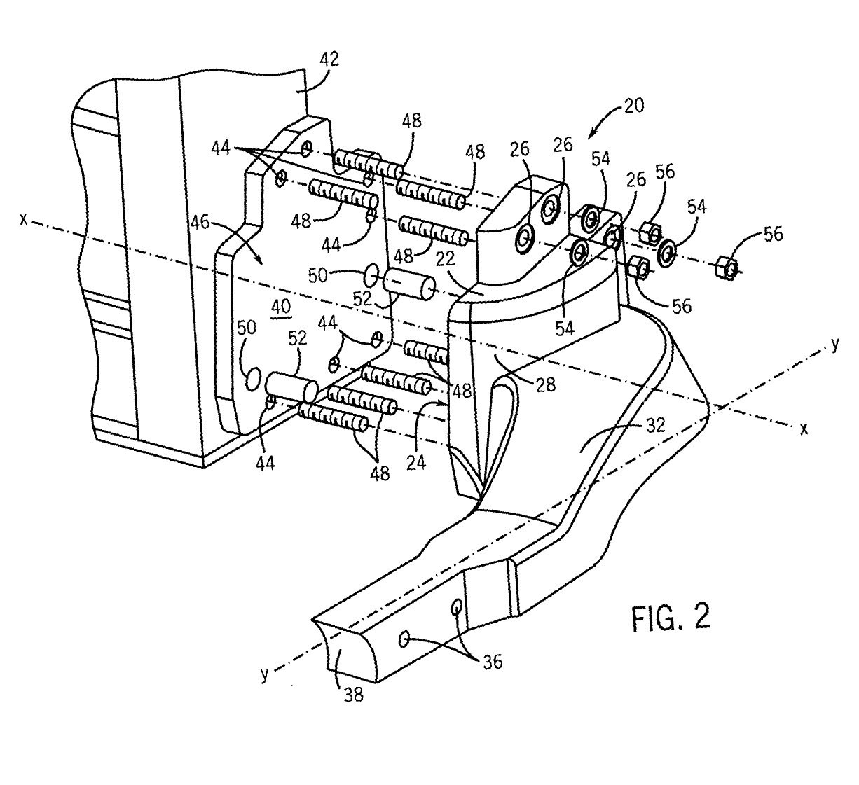

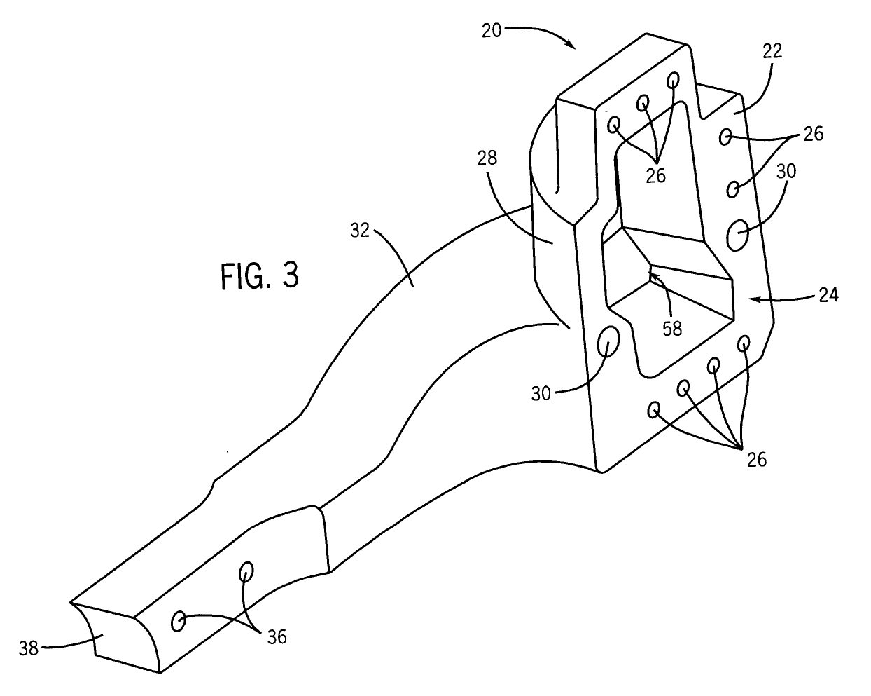

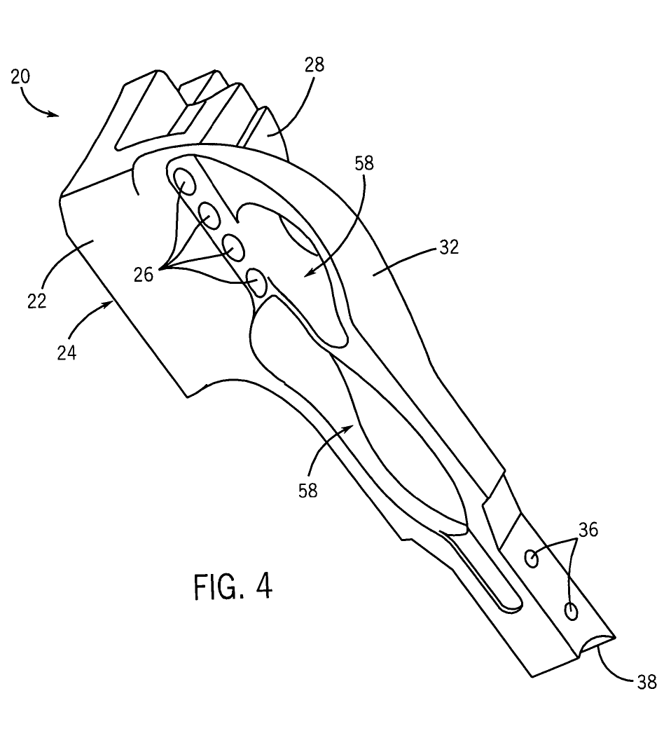

Referring to FIGS. 2-4, a base leg assembly according to the present invention includes a base leg 20, which is a single piece casting, preferably made of ductile iron. In addition to casting, the base leg 20 could be made by other manufacturing means, such as machining from a block of solid material. Essential to the present invention is only that the base leg 20 be a single unit and not made up of various individual pieces.

The base leg 20 includes an integrally formed mounting portion 22 and leg portion 32. The mounting portion 22 incorporates the means for mounting the base leg 20 to a mounting plate 40, which is discussed in more detail below, and provides the main structure from which the rest of the base leg 20 is formed. The mounting portion 22 includes an inner surface 24, which is preferably planar, but could be any shape that allows the inner surface 24 to engage a mounting surface 46 of the mounting plate 40. Apertures 26 extend completely through the mounting portion 22 and are countersunk on the outer surface 28 of the mounting portion 22. Bores 30 extend into the mounting portion 22 from the inner surface 24 and do not extend completely through the mounting portion 22.

The leg portion 32 has a proximal end at the mounting portion 22 and extends laterally outward from the outer surface 28 of the mounting portion 22 along an axis X (see FIGS. 2, 8a, and 10), which is substantially perpendicular to the inner surface 24 of the mounting portion 22. The leg portion 32 transitions approximately 90 degrees in direction between the proximal end and the distal end such that the leg portion 32 at the distal end extends forward of the mounting portion and the lift truck along an axis Y (see FIGS. 2, 8a, and 10), which is substantially parallel to the inner surface 24 of the mounting portion 22.

The distal end of the leg portion 32 engages load wheel plates 62, which are discussed in more detail below. The width of the distal end of the leg portion 32 transitions to a smaller width such that when the base leg 20 is assembled with the load wheel plates 62 the outer surfaces are substantially continuous, which avoids creating a location for engaging objects, such as rack support columns in a warehouse. A transverse bore 36 extends through the smaller width of the distal end of the leg portion 32. The end of the distal end of the leg portion 32, shown generally at 38, has a concave profile and is shaped such that the surface of the end 38 is substantially coplanar with the outer surface of a load wheel 90, which prevents materials from wrapping onto the load wheels 90.

Cavities 58 are formed within the base leg 20. There is no preferred location, shape, number, or size of the cavities 58 as these characteristics depend on the particular shape of the base leg 20 and will be optimized to reduce the weight of the base leg 20 and to assist in the distribution of the stresses throughout the base leg 20 so that there are no concentrated areas of high stress, which increases the flexibility and strength of the base leg 20 compared to a base leg formed of welded steel plates or tube steel.

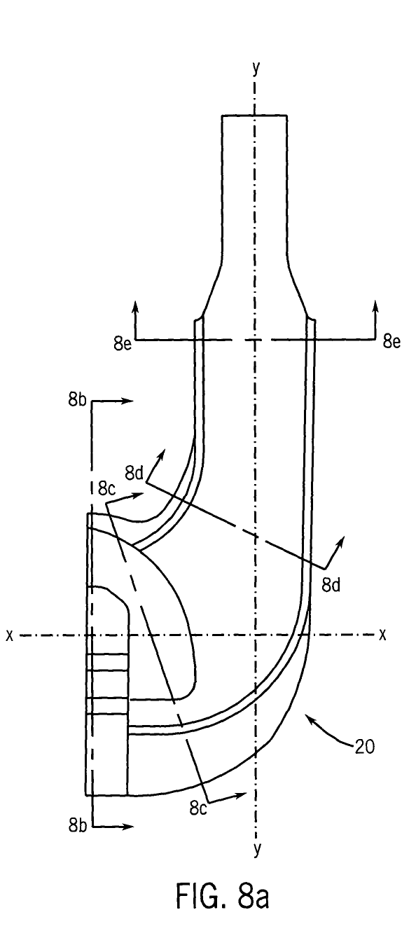

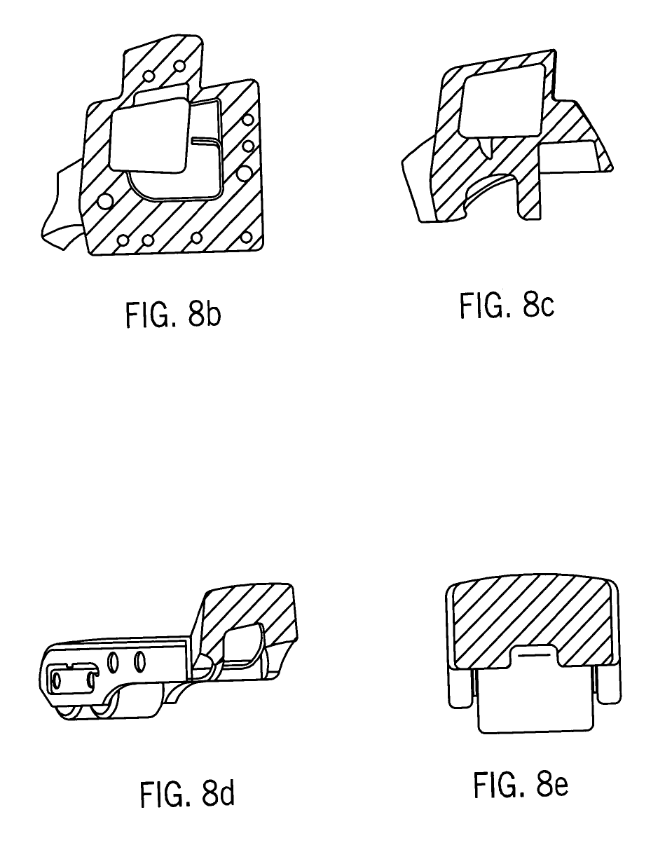

As shown in FIGS. 8a-8e, the cross sectional area of the base leg 20 is greatest at the mounting portion 22 and decreases to a smaller cross sectional area at the distal end of the leg portion 32. This “wine bottle” shape distributes the stresses throughout the base leg 20, transitions the stresses from the load wheel assembly 60 to the base leg 20, and optimizes material usage.

Referring to FIG. 2, a mounting plate 40 is welded to the lift truck at either the mast structure 42 or the body structure (not shown) or is fastened by some other acceptable means such as by bolts, screws, etc. The mounting plate 40 has a mounting surface 46 that is preferably planar, but, as discussed above, could be any shape that allows the mounting surface 46 to engage the inner surface 24 of the base leg 20. Internally threaded apertures 44 extend transversely into the mounting plate 40 and receive threaded fasteners 48, such as bolts. Bores 50 also extend transversely into the mounting plate 40 and receive pins 52. The diameter of the pins 52 is greater than that of the threaded fasteners 48, and the pins 52 do not extend all the way through the mounting plate 40 or the base leg 20.

To fasten the base leg 20 to the mounting plate 40 the threaded fasteners 48 are threaded into the internally threaded apertures 44 of the mounting plate 40 and the pins 52 are inserted into the bores 50 in the mounting plate 40. The base leg 20 is then placed on the mounting plate 40 such that the threaded fasteners 48 extend through the apertures 26 in the base leg 20, the pins 52 are inserted into the bores 30 in the base leg 20, and the inner surface 24 of the base leg 20 fully engages the mounting surface 46 of the mounting plate 40. The base leg 20 is then fastened by placing washers 54 and nuts 56 on the ends of the threaded fasteners 48 extending past the outer surface 28 of the base leg 20.

The threaded fasteners 48 and the pins 52 accurately locate and orient the base leg 20 relative to the mounting plate 40 and are removable from both the mounting plate 40 and the base leg 20. The threaded fasteners 48 form a uniformly loaded (bending) structural joint and the pins 52 form a uniformly loaded (torsion and shear) structural joint between the base leg 20 and the mounting plate 40. The joint formed by the pins 52 and threaded fasteners 48 provides an accurate, secure, and replaceable means of attaching the base leg 20 to the mounting plate 40 and resists the bending, shear, and torsion loading associated with the lift truck application.

Alternatively, the base leg 20 can also be welded directly to the mounting plate 40. However, welding the base leg 20 directly to the mounting plate 40 would give up some of the ease of assembly and replacement and flexibility for reconfiguring the lift truck to a customer's application.

Referring to FIG. 5, the load wheel assembly 60 includes a pair of load wheel plates 62, which are mirror images of each other. Each load wheel plate 62 is a single piece casting, preferably made of ductile iron. In addition to casting, the load wheel plates 62 could be made by other manufacturing means, such as machining from a block of solid material or by a welded and machined construction.

Each load wheel plate 62 has an inner surface 64 that engages the outer surface of the distal end of the leg portion 32 of the base leg 20. The top surface 66, outside surface 68, and bottom surface (not shown) are shaped such that the outer shape of the leg portion 32 is substantially continued from the base leg 20 through the load wheel assembly 60. Bores 70 extend transversely through the load wheel plates 62 and are aligned with the transverse bores 36 in the base leg 20. Each bore 70 is also countersunk on the outside surface 69 of each load wheel plate 62.

An elongated aperture 74 extends transversely through each load wheel plate 62 and receives the load wheels (not shown). Preferably, the elongated apertures 74 are shaped such that they will receive different numbers, sizes, and types of load wheels.

Cavities 70 are formed within each load wheel plate 62. There is no preferred location, shape, number, or size of the cavities 70 as these characteristics depend on the particular shape of each load wheel plate 62 and will be optimized to reduce the weight of the load wheel plates 62 and to assist in the distribution of the stresses throughout the load wheel plates 62 so that there are no concentrated areas of high stress, which will increase the flexibility and strength of the load wheel assembly 60 compared to a load wheel assembly formed of welded steel plates.

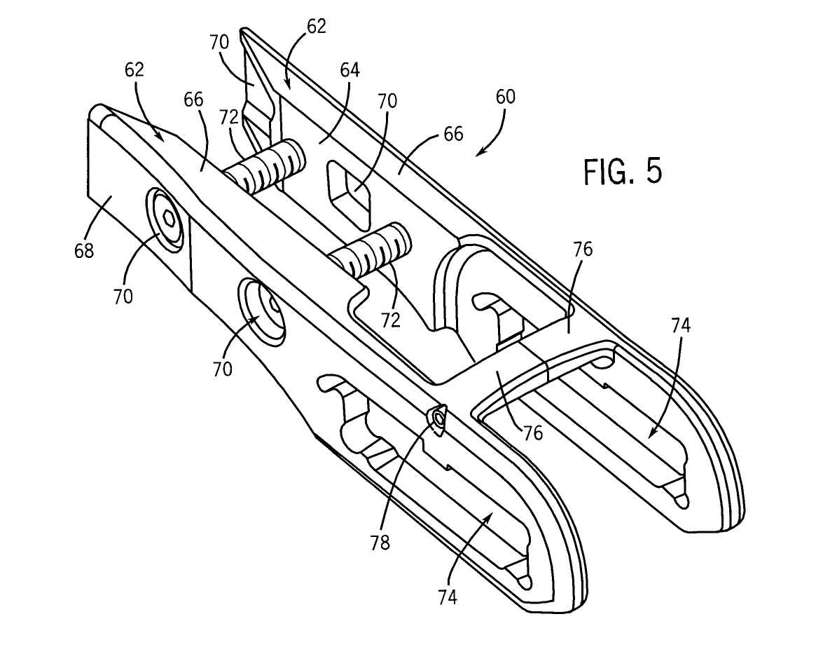

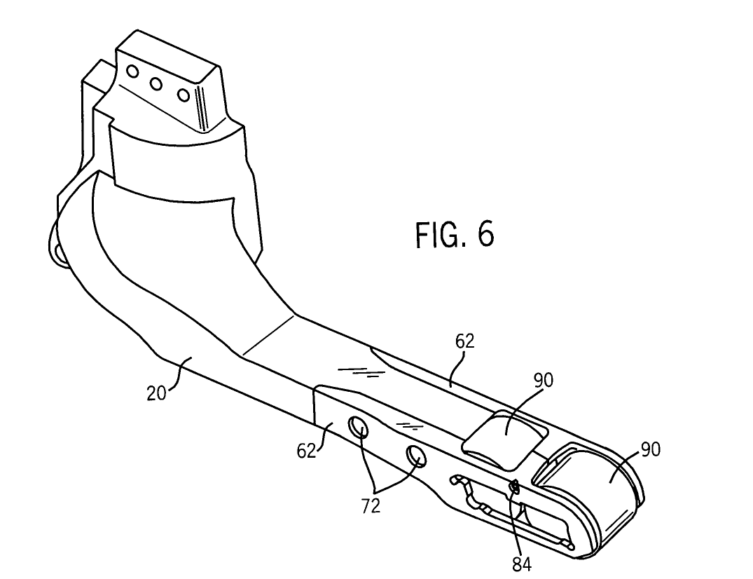

Referring to FIG. 6, the load wheel assembly 60 is fastened to the base leg 20 by placing one load wheel plate 62 on each side of the distal end of the base leg 20, placing the load wheels 90 between the elongated apertures 74 such that they are supported between the elongated apertures 74 and can rotate therein, and inserting threaded fasteners 72, such as bolts, through the bores 70 in the load wheel plates 62 and the transverse bores 36 in the base leg 20 and securing the threaded fasteners 72 with washers and nuts (not shown). The heads of the threaded fasteners 72, washers, and nuts, are all disposed below the outside surface 68 of each load wheel plate 62 by the countersinks. Fastening the load wheel plates 62 to the base leg 20 with threaded fasteners 72, as opposed to welding, allows the easy replacement of the load wheel plates 62 for maintenance, repair, replacement, or customization.

In the preferred embodiment of the present invention, a cross bridge 76 extends from the inner surface 64 of each load wheel plate 62 to provide added strength and stability to the load wheel assembly 60 and to protect the load wheels 90. In addition, a bore 78 extends transversely through each load wheel plate 62 just below the cross bridge 76 and above the elongated aperture 74 and is countersunk on the outer surface 68 of each load wheel plate 62. A threaded fastener 84, such as a bolt, is inserted through the bores 78 in the load wheel plates 62 and is secured with a washer and nut (not shown), which also provides added strength and stability to the load wheel assembly 60. However, if added strength, stability, and/or protection are not needed or desired, the cross bridge 76 and the bores 78 could be removed.

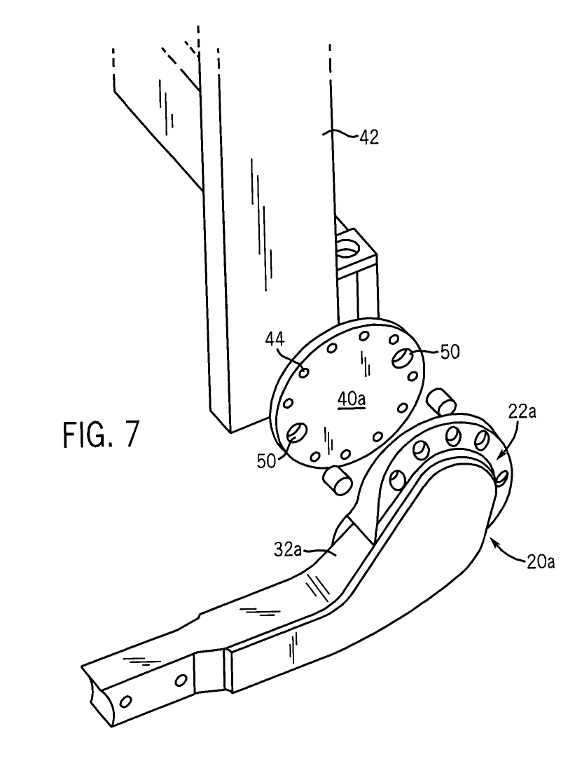

Referring to FIG. 7, an alternate embodiment of the mounting plate and base leg is shown. In this alternate embodiment, the mounting plate 40a is circular and the interior threaded apertures 44 and bores 50 are located along the outer edge of the mounting plate 40a. In addition, the mounting portion 22a of the base leg 20a is also circular and is similarly engages the mounting plate 40a. The leg portion 32a is still integrated with the mounting portion 22a and extends at its proximal end from the mounting portion 22a radially along an axis that is substantially parallel to the inner surface of the base leg 20a. Other than the above changes, the characteristics of the mounting plate 40a and the base leg 20a are the same as those of the mounting plate 49 and base leg 20 described above.

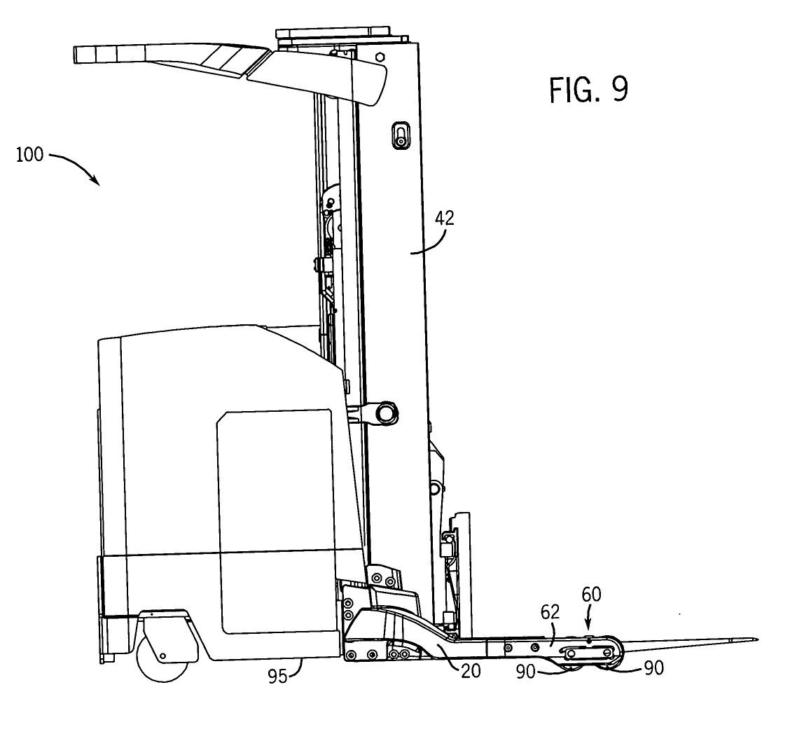

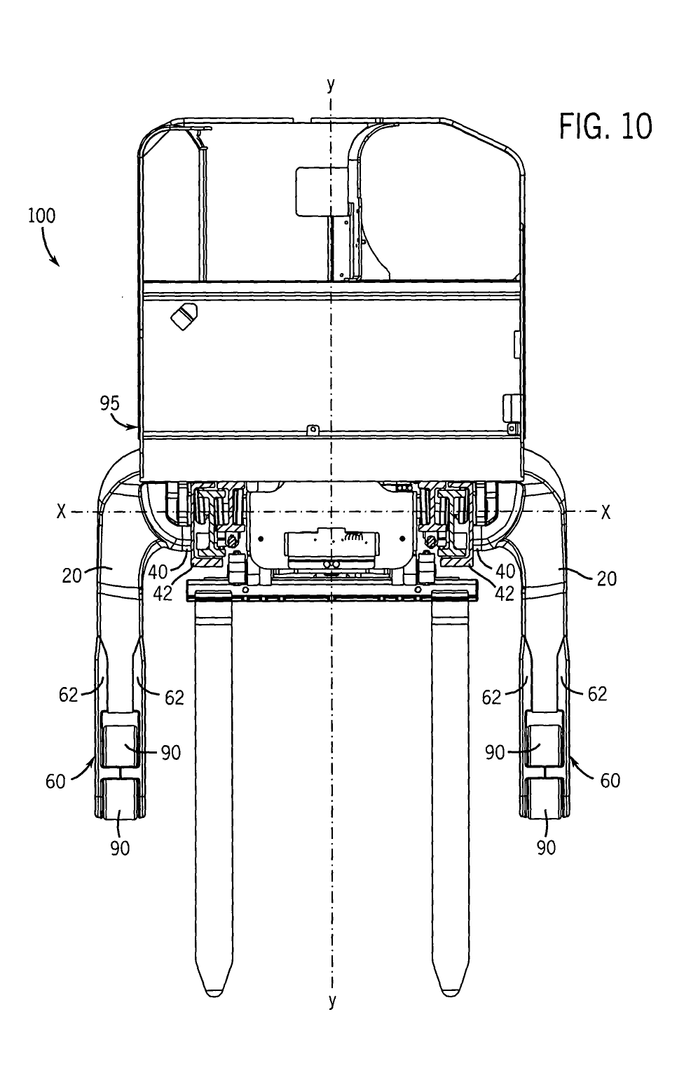

Referring to FIGS. 9 and 10, a lift truck 100 is shown with base leg assemblies according to the preferred embodiment of the present invention. The structure of lift trucks is well known, therefore the details will not be described herein except as relevant to the present invention. The lift truck 100 has a body structure 95, which includes the basic frame, driving unit, power unit, control unit, etc. for the lift truck 100. A mast structure 42 is fastened to the body structure 95 with bolts, by welding, or by some other acceptable means. A base leg 20 is fastened at one end to the mast structure 42 via a mounting plate (not shown) and is fastened to a load wheel assembly 60 at the opposite end. Alternatively, as discussed above, the base leg 20 could also be fastened to the body structure 95, rather than the mast structure 42.

### Summary of Testing

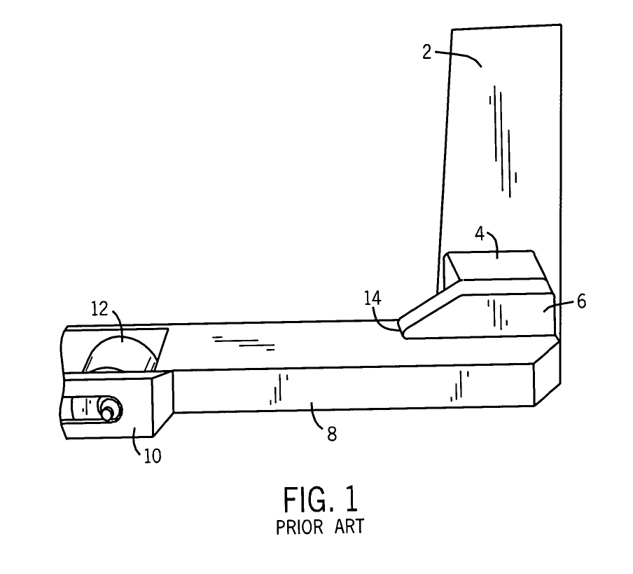

Testing of numerous welded base leg assemblies of a type shown in FIG. 1 showed consistent failure of the assemblies at approximately 300,000 cycles (when loaded at a percentage above normal to facilitate reasonable time to witness fracture). The weld joint would typically begin to crack at the toe of the gusset plate (indicated at 14 in FIG. 1) and the crack would then propagate across the leg and then down the side of the leg. Conversely, testing of numerous base leg assemblies manufactured according to the preferred embodiment of the present invention showed failure of the assemblies at approximately 1,500,000-2,000,000 cycles. In fact, one unit tested ran more than 7,000,000 cycles without failure.

While the foregoing specification illustrates and describes the preferred embodiments of this invention, it is to be understood that the invention is not limited to the precise construction herein disclosed. The invention can be embodied in other specific forms without departing from the spirit or essential attributes of the invention. Accordingly, reference should be made to the following claims, rather than to the foregoing specification, as indicating the scope of the invention.

1. A base leg assembly for a lift truck, comprising:
a mounting plate fastened to the lift truck; and
a base leg having an integrally formed mounting portion and leg portion, the mounting portion engaging a mounting surface on the mounting plate and being fastened to the mounting plate, and the leg portion extending outward from the mounting portion and extending forward of the lift truck.

2. A base leg assembly, as recited in claim 1, wherein the base leg is cast.

3. A base leg assembly, as recited in claim 1, wherein at least one cavity is formed within the base leg.

4. A base leg assembly, as recited in claim 1, wherein the leg portion extends laterally outward from the mounting portion and transitions approximately 90 degrees in direction between a proximal end at the mounting portion and a distal end of the leg portion.

5. A base leg assembly, as recited in claim 1, wherein the cross sectional area of the leg portion of the base leg decreases from a proximal end to a distal end thereof.

6. A base leg assembly, as recited in claim 1, wherein a load wheel assembly is fastened to a distal end of the leg portion.

7. A base leg assembly, as recited in claim 1, wherein the mounting plate is welded to the lift truck.

8. A base leg assembly, as recited in claim 1, wherein the mounting plate is fastened to the lift truck with at least one bolt.

9. A base leg assembly, as recited in claim 1, wherein the base leg is welded to the mounting plate.

10. A base leg assembly, as recited in claim 1, wherein:
the mounting plate has an internally threaded aperture;
the mounting portion of the base leg has an aperture aligned with the threaded aperture in the mounting plate; and
the base leg is fastened to the mounting plate with a threaded fastener that is received in the internally threaded aperture of the mounting plate, inserted through the aperture in the mounting portion of the base leg, and secured with a nut.

11. A base leg assembly, as recited in claim 1, wherein:
the mounting plate has an internally threaded aperture and a first bore;
the mounting portion of the base leg has an aperture aligned with the threaded aperture in the mounting plate and a second bore aligned with the first bore in the mounting plate; and
the base leg is fastened to the mounting plate with a pin disposed within the first and second bores and a threaded fastener that is received in the internally threaded aperture of the mounting plate, inserted through the aperture in the mounting portion of the base leg, and secured with a nut.

12. A base leg assembly, as recited in claim 6, wherein the load wheel assembly comprises:
a pair of spaced upright load wheel plates that fasten to the distal end of the base leg and extend forward therefrom; and
a load wheel, rotatably mounted between the first and second load wheel plates.

13. A base leg assembly, as recited in claim 12, wherein each load wheel plate is cast.

14. A base leg assembly, as recited in claim 12, wherein at least one cavity is formed in each load wheel plate.

15. A base leg assembly, as recited in claim 12, wherein:
the distal end of the leg portion of the base leg includes a transverse bore;
each load wheel plate includes a bore aligned with the transverse bore in the base leg; and
the load wheel plates are fastened to the base leg with a threaded fastener extending through the bores and the transverse bore.

16. A base leg assembly, as recited in claim 12, wherein:
each load wheel plate includes an elongated aperture for receiving a variety of styles and sizes of load wheels; and
the load wheel is rotatably supported by the elongated apertures.

17. A base leg assembly, as recited in claim 16, wherein:
each load wheel plate includes a bore disposed above the elongated aperture; and
a threaded fastener is secured through the bores.

18. A base leg assembly for a lift truck, comprising:
a mounting plate welded to the lift truck to provide a mounting surface;
a base leg having an integrally cast mounting portion and leg portion and at least one cavity formed therein, the mounting portion engaging the mounting surface of the mounting plate and being fastened to the mounting plate, the leg portion extending laterally outward from the mounting portion and transitioning approximately 90 degrees in direction between a proximal end at the mounting portion and a distal end of the leg portion, the cross sectional area of the leg portion decreasing from the proximal end to the distal end thereof; and
a load wheel assembly fastened to the distal end of the leg portion.

19. A base leg assembly for a lift truck, comprising:
a mounting plate, welded to the lift truck to provide a mounting surface, having an internally threaded aperture and a first bore formed therein;
a base leg having an integrally cast mounting portion and leg portion and at least one cavity formed therein, the mounting portion engaging the mounting surface of the mounting plate and having an aperture, aligned with the internally threaded aperture in the mounting plate, and a second bore, aligned with the first bore in the mounting plate, formed therein, the base leg being fastened to the mounting plate with a pin disposed within the first and second bores and a threaded fastener that is received in the internally threaded aperture of the mounting plate, inserted through the aperture in the mounting portion of the base leg, and secured with a nut, the leg portion extending laterally outward from the mounting portion and transitioning approximately 90 degrees in direction between a proximal end at the mounting portion and a distal end of the leg portion, the distal end having a transverse bore, and the cross sectional area of the leg portion decreasing from the proximal end to the distal end thereof, and the distal end;
a pair of spaced upright load wheel plates having at least one cavity formed therein, a first bore aligned with the transverse bore in the base leg, and a second bore, the load wheel plates being fastened to the base leg with a threaded fastener extending through the bores and the transverse bore; and
a load wheel, disposed between and rotatably supported by the load wheel plates.

20. A lift truck, comprising:
a body structure;
a mast structure fastened to the body structure;
a mounting plate fastened to the lift truck; and
a base leg having an integrally formed mounting portion and leg portion, the mounting portion engaging a mounting surface on the mounting plate and be fastened to the mounting plate, and the leg portion extending outward from the mounting portion and extending forward of the lift truck.

21. A lift truck, as recited in claim 20, wherein the mounting plate is fastened to the body structure of the lift truck.

22. A lift truck, as recited in claim 20, wherein the mounting plate is fastened to the mast structure of the lift truck.

23. A lift truck, as recited in claim 20, wherein the base leg is cast.

24. A lift truck, as recited in claim 20, wherein at least one cavity is formed within the base leg.

25. A lift truck, as recited in claim 20, wherein the leg portion extends laterally outward from the mounting portion and transitions approximately 90 degrees in direction between a proximal end at the mounting portion and a distal end of the leg portion.

26. A lift truck, as recited in claim 20, wherein the cross sectional area of the leg portion of the base leg decreases from a proximal end to a distal end thereof.

27. A lift truck, as recited in claim 20, wherein the base leg is welded to the mounting plate.

28. A lift truck, as recited in claim 20, wherein:
the mounting plate has an internally threaded aperture;
the mounting portion of the base leg has an aperture; and
the base leg is fastened to the mounting plate with a threaded fastener that is received in the internally threaded aperture of the mounting plate, inserted through the aperture in the mounting portion of the base leg, and secured with a nut.

29. A lift truck, as recited in claim 20, wherein:
the mounting plate has an internally threaded aperture and a first bore;
the mounting portion of the base leg has an aperture and a second bore; and
the base leg is fastened to the mounting plate with a pin disposed within the first and second bores and a threaded fastener that is received in the internally threaded aperture of the mounting plate, inserted through the aperture in the mounting portion of the base leg, and secured with a nut.

30. A lift truck, as recited in claim 20, further comprising:
a pair of spaced upright load wheel plates that fasten to a distal end of the base leg and extend forward therefrom; and
a load wheel, rotatably mounted between the first and second load wheel plates.

31. A lift truck, as recited in claim 30, wherein each load wheel plate is cast.

32. A lift truck, as recited in claim 30, wherein at least one cavity is formed in each load wheel plate.

33. A lift truck, as recited in claim 30, wherein:
the distal end of the leg portion of the base leg includes a transverse bore;
each load wheel plate includes a bore aligned with the transverse bore in the base leg; and
the load wheel plates are fastened to the base leg with a threaded fastener extending through the bores and the transverse bore.

34. A lift truck, as recited in claim 30, wherein:
each load wheel plate includes an elongated aperture for receiving a variety of styles and sizes of load wheels; and
the load wheel is rotatably supported by the elongated aperture.

35. A lift truck, as recited in claim 34, wherein:
each load wheel plate includes a bore disposed above the elongated aperture; and
a threaded fastener is secured through the bores.

36. A base leg assembly for a lift truck having a mounting surface, the combination comprising:
an integrally formed base leg having a mounting portion which engages the mounting surface and is fastened thereto, and a leg portion which extends laterally outward from the mounting portion, and then in the forward direction to terminate at a distal end; and
a load wheel assembly fastened to the distal end of the base leg and having a rotatable load wheel.

37. The assembly as in claim 36 in which the mounting portion of the base leg is removably fastened to the mounting surface with a threaded fastener.
